(19) United States
(12) Patent Application Publication
(10) Pub. No.: US 2005/0162689 A1
(43) Pub. Date: Jul. 28, 2005

(54) System and method for communicating with printers using web site technology

(75) Inventor: Tomas Roztocil, Caledonia, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/020,989

(22) Filed: Dec. 22, 2004

Related U.S. Application Data
(60) Provisional application No. 60/538,943, filed on Jan. 23, 2004.

(51) Int. Cl. G06F 15/00

(52) U.S. Cl. 358/1.15

(57) ABSTRACT

A method of controlling a printer is disclosed wherein a printer is provided with software to host its own web site, wherein the printer has its own URL http based address so that a user interface can interact with the printer via interconnection with the internet in order to provide access to and control the printer.

### CROSS REFERENCE TO RELATED APPLICATIONS

This application claims the benefit of the filing date from Provisional Application Ser. No. 60/538,943 entitled “SYSTEM AND METHOD FOR COMMUNICATING WITH PRINTERS USING WEB SITE TECHNOLOGY” filed on Jan. 23, 2004.

### FIELD OF THE INVENTION

The present invention relates to printers, and more particularly to controlling print production utilizing web site technology.

### BACKGROUND OF THE INVENTION

While just about every computer user owns their own printer and is capable of producing high quality documents, the ability to produce such documents in high volume and with special finishing features, such as binding, is still within the purview of the commercial print shops and corporate copy departments due to the high cost and operational complexities involved. High volume, finished production of documents is typically referred to as production printing. A production printer is a printing device capable of rapid continuous production of large volumes of documents. Typically these printers have high paper handling capacity, the ability to draw on multiple media types from multiple sources and the ability to automatically finish a document such as by adding a binding. Despite the automation provided by the production printer and the proliferation of computer technology, especially in the area of desktop publishing, production printing is still a complicated and often manual process.

In a typical print shop, customers bring in original documents which they want turned into a finished product such as a bound booklet, a tri-fold brochure or a tabbed three ring bound notebook. In addition, they typically need a large volume of the finished product, for example, one thousand brochures. The combination of the original documents plus the instructions for producing the finished product is called a “job”. The documents can be brought in either in hard copy or electronic form, such as on floppy disk, compact disc or tape or can be transmitted to the print shop over a network such as the Internet.

After handing over the documents to the clerk, the customer relays his instructions for preparing the finished product. The clerk will note these instructions on a “ticket” or “job ticket”. The job ticket is typically a piece of paper with all of the instructions written on it for producing the finished product. As mentioned above, this is known as job. The job will then be handed to an operator, who runs the production printer, to produce the finished output. The operator's job is to prepare the document for production, load the appropriate materials, such as paper stock and binding materials, into the production printer and ensure that the finished output is correct.

While the job of the operator seems simple, there are many issues which quickly complicate it. Often, the documents provided by a customer are not ready to be run on the production printer. Some documents provided by a customer are merely raw manuscripts requiring basic formatting, such as margins, typography, etc. Other documents may be formatted but such formatting might not take into account the requested binding. For example, the text of the document is too close to the margin, therefore, when the finished product is bound, some of the text will be obscured. Some documents, such as books, require special care so that, for example, the first page of every chapter appears on the front of a page, also known as imposition. Other forms of imposition include booklet/pamphlet imposition or n-up imposition. Or the customer may bring in multiple documents and ask that these “chapters” be assembled into a book, with a cover and binding.

Other issues which complicate the production printing job are determining and loading the correct media into the production printer. Often, jobs will require many different paper types, such as different stock weights or different colors. In addition, some jobs require the insertion of tab stock at specific points within the document. Still other jobs may require the adding of a bates number or other annotation to the document.

Production printers run at very high speeds, often producing output greater than 1 page per second therefore, errors in the finished output may not be caught before a significant amount of time and resources have been wasted.

Accordingly, there is a need for an efficient system and method for managing production printing and ensuring error-free output.

### BRIEF DESCRIPTION OF THE DRAWINGS

FIG. 1 depicts a flow diagram illustrating a production printing workflow in accordance with the present invention;

FIG. 2 depicts a flow diagram showing user functionality workflow in accordance with the present invention;

FIG. 3 depicts a graphic user interface according to a first embodiment in accordance with the present invention;

FIG. 4 depicts a graphic user interface according to a second embodiment in accordance with the present invention;

FIG. 5 depicts a library of symbolic icons representing various media/finishing attributes for use with the embodiment of FIG. 4;

FIG. 6 depicts a schematic diagram showing the interconnection architecture of a print production system;

FIG. 7 represents a block diagram of an image-forming machine having a graphic user interface with interconnection architecture where a software application implements a functionality and provides a plug-in interface with another software application;

FIG. 8 represents a block diagram showing the interconnection architecture of a first software application with a second software application according to a first embodiment;

FIG. 9 represents a block diagram showing the interconnection architecture of a first software application with a second software application according to a second embodiment;

FIG. 10 represents a block diagram showing the interconnection architecture of a second software application with a second software application according to a third embodiment; and

FIG. 11 represents a block diagram showing a graphic user interface in accordance with the present invention.

### DETAILED DESCRIPTION

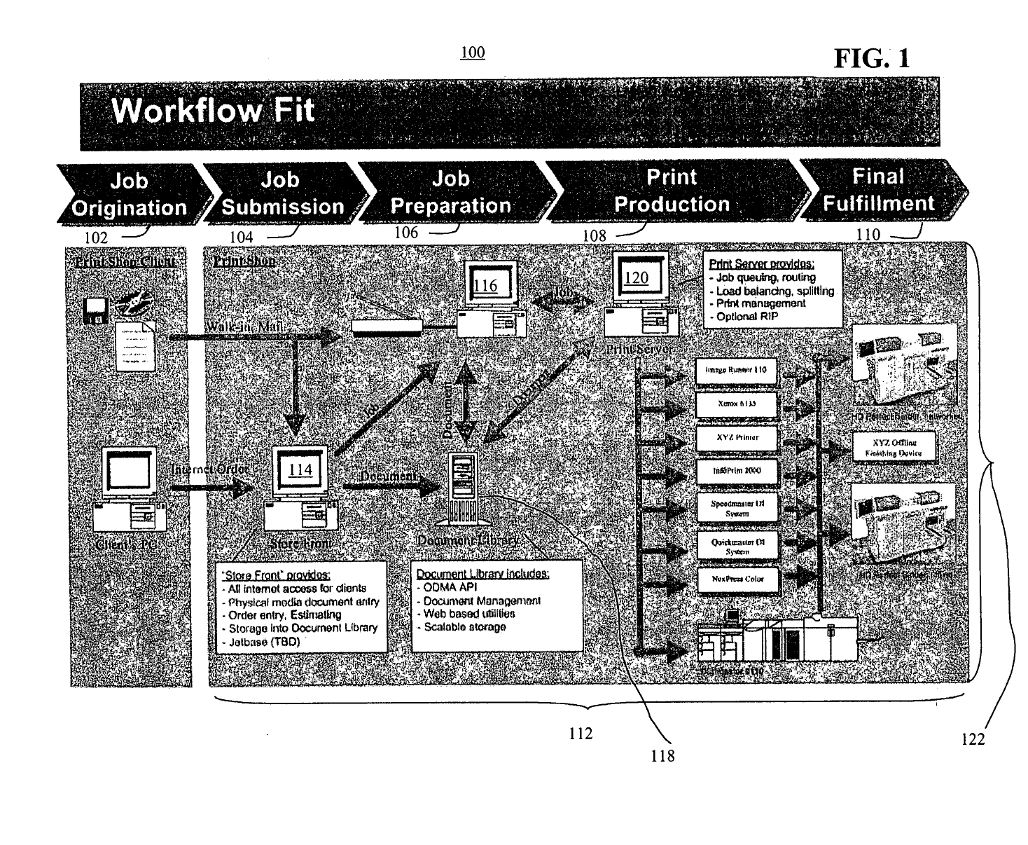

Referring now to FIG. 1, there is shown a flow diagram illustrating the production work flow 100 in a typical production print shop such as a commercial high volume copy or print shop. A workflow is defined as the tasks, procedural steps, organizations or people involved, required input and output information, and tools needed for each step in a business process. A workflow approach to analyzing and managing a business or process such as production printing can be combined with an object oriented approach, which tends to focus on the discrete objects and processes involved such as documents, pages, data and databases. For the purposes of this disclosure, the term “object oriented”, when applied to the disclosed embodiments, does not imply that an object oriented programming approach is the only method of implementation of the disclosed embodiments.

FIG. 1 further depicts a typical computer network 118 for use in a print shop. In a typical digital print shop, there will be a network 118 of computer work stations 114, 116, servers 118, 180 and high volume output devices 122 which make up the computer network 118. The servers 118, 180 include network servers 118 and print servers 180. The topology of the network 118 is typically structured so as to align with the workflow 100 of the print shop. The network 118 may be implemented as a wired or wireless Ethernet network or other form or local area network. Further the network 118 may include wired or wireless connections to wide area networks such as the Internet and connections to other local area networks such as through a virtual private network.

The production workflow 100 includes the procedural stages of job origination 102, job submission 104, job preparation 106, print production 108 and final fulfillment 110. Alternatively, one or more of these procedural stages may be combined as well as there may be other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. Note that a job may contain more than one document and more than one set of instructions. For example, a job may contain many documents, each being one chapter of a book, along with a document containing a cover for the book. This exemplary job may include the instructions for producing the body of the book from the individual chapter documents and another set of instructions for producing the cover. In addition, there may be a third set of instructions for assembling the cover to the body of the book.

Job submission 104 is the receipt of the job by the print shop and the entering of the job into the print shops production system or workflow. Typically the instructions from the customer will be written down on a special form, known as a “ticket” or “job ticket”. A ticket may also be electronically created and maintained. Furthermore, pre-defined tickets may be available for standardized instructions. For example, the shop may have a pad of pre-printed tickets with the instructions to duplicate the documents, three hole punch the final output and assemble the punched final output in a three ring binder. If this is a common request by customers, such pre-printed tickets can save time and resources. All the order taking clerk need do is fill in any customer specific details such as the number of copies to produce. Pre-defined tickets standardize operations and prevent errors in the transcription of instructions from the customer. In very simple print shops, job submission 104 may simply be the receiving of the original documents and instructions along with the creation of a ticket, placing the job in a paper folder and setting it in a physical queue for later handling in subsequent procedural stages.

In print shops which handle jobs electronically, job submission 104 requires entering the job into the shops electronic production system. For documents which are brought in by the customer as hard copy, the documents must first be scanned electronically into the shop's computer system. For documents delivered in electronic form, the document data files must be loaded on the shop's computer system.

For the job submission stage 104, the computer network 112 will include one or more “store front” workstations 114. The store front workstations 114 are computer system is placed at the order taking desk, at a manned clerk's station or set out for customer self service use. These workstations 114 are used for the job submission stage 104 and typically will be configured to handle many different electronic media types such as floppy disk, compact disc, tape, etc. These stations 114 may also be configured to receive jobs over the Internet or other form of network connection with customers. Further, these workstations 114 are typically configured to read many different electronic file formats such as those used by the Microsoft Office™ family of products manufactured by Microsoft Corporation, located in Redmond, Wash. or various other desktop publishing program file formats such as Aldus Pagemaker™ or QuarkXpress™. In addition, these stations 114 can also read “ready for printer” file formats, which will be discussed later, such as Portable Document Format™ (“PDF”), Postscript™ (“PS”) or printer control language (“PCL”). Job preparation stations 114 can also accept image formats such as Tagged Image File Format (“TIFF”), bitmap (“BMP”) and PCX. These stations 114 may also include a scanner 116 for scanning hard copies of documents into the computer system. Scanners typically are complicated devices to operate and some print shops may prefer to locate the scanners in the job preparation stage 106 for use solely by trained personnel as will be discussed below. In addition, the store front computers 114 also provide the ability to generate a ticket, electronically or in hard copy form, for the job containing all of the instructions for completing the production printing task. This process of generating the ticket may be automated, involving pre-defined tickets, manual or a combination thereof, and is discussed in more detail below.

Job preparation 106 involves preparing the documents for printing according to the instructions in the ticket. For documents that are submitted in hard copy form, job preparation 106 may include scanning the documents and creating a faithful and error free electronic reproduction. The documents, once in electronic form, must also be distilled down or converted into a common file format that the print shop can use to both edit and print the documents. This alleviates the need for operators to deal with multiple different programs and eliminates the need to assemble complex documents together for printing using different electronic file formats.

For example, a customer may bring in two different documents, one being the body of a book and the other being the photographs to be inserted at specific pages. The customer may then instruct that the photographs be inserted at particular pages and that the final assembly have continuous page numbers added. The body of the book may be in Microsoft Word™ format while the images of the photographs are in Adobe Photoshop™ format. While the operator could figure out at which pages the images will be inserted and appropriately number the pages of the book and photographs using each individual software package, this is a very complex and time consuming process. It also requires that the operator be trained and familiar with a range of software packages and runs the risk that he will not be familiar with the particular package that the customer used. Therefore, it is more efficient to distill each of the various file formats into a unified format which allows the operator to prepare the job using a single software interface. In the present embodiments, all documents, whether provided in hard copy or electronically, are distilled or converted into a “ready for printer” or “print ready” file format. In the present embodiments, the Portable Document Format™ is used as the ready for printer format, developed by Adobe Systems, Inc., located in San Jose, Calif.

A ready for printer file format is defined as a file format which contains both the data to be printed along with printer control instructions that can be directly interpreted by the internal processing engine of a printer or other form of hard copy output device in order to rasterize the data image onto the output media. Rasterization is the placement of image data at a specific location on the output media. Such file formats include Portable Document Format™ (“PDF”) and Postscript™ (“PS”) both manufactured by Adobe Systems, Inc., located in San Jose, Calif., as well as printer control language (“PCL”), manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the Tagged Image File Format (“TIFF”) contain bit image data only which is already in a format which specifies its output location on the output media and does not contain printer control instructions for interpretation by the internal processing engine of the printer and therefore, for the purposes of this disclosure, is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the operator's expectations.

For the job preparation stage 106, the computer network 106 includes job preparation stations 116 and network servers 118 coupled with the store front workstations 114 over the network 112. Herein, the phrase “coupled with” is defined to mean directly connected to or indirectly connected with through one or more intermediate components. Such intermediate components may include both hardware and software based components. The job preparation stations 116 preferably execute workflow management software, described in more detail below, which allows the operator to manage, edit and print jobs. The network server(s) 118 includes a document library which allows manipulation, management, storage and archiving of jobs, or just there respective documents and/or tickets, as well as facilitates and manages the flow of jobs from the store front computers 114 to the job preparation stations 116 and from the job preparation stations 116 to the print servers 120 or the production output devices 122. Exemplary document libraries include Intra.Doc™ document management system manufactured by Intranet Solutions, Inc., located in Eden Prairie, Minn. and the DOCFusion document management system manufactured by Hummingbird, Inc., located in York, Ontario, Canada. In the present embodiment, the job preparation stations 116 are Imagesmart™ Workstations, manufactured by Heidelberg Digital, L.L.C., located in Rochester, N.Y. Alternatively, an appropriate computer hardware platform such as that comprising a Pentium™ class processor or better, manufactured by Intel Corporation, located in Santa Clara, Calif., 64 megabytes of RAM or more, a 80 gigabyte hard disk or larger and appropriate display device may be used. Further, in the present embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, bates numbering, adjusting page layout for tab stock and aligning the output to account for binding. Further the job preparation stations 114 provide the capability to fix errors in the documents such as removing artifacts in scanned images and masking over unwanted text or markings. The job preparation stations 114 can also be used to prevent inaccuracies in the finished output caused by the printing or binding process. Such inaccuracies include binder's creep which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep is prevented by gradually shifting the image placement over the range of pages when performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet, also known as “n-up” to create proof sets, brochures or pamphlets, etc. Further the job preparation station 116 permits the operator to add annotations to the document such as bates numbers, page numbers, logos and watermarks. All of these service add value to the final output. Formatting and other modifications to the document can be globally applied to the entire document, such as a shifted margin or may be applied only to select pages. Such alterations to the document are known as document/page features or attributes. Further, these alterations are also known as document or page exceptions since they typically override specific instances of the original document formatting as set by the customer.

The next stage in the print production workflow 100 is the print production stage 108. In the print production stage 108, the final form of the documents for printing is sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIPping the job, prior to sending it to a particular device 122. RIP stands for Raster Image Processor and is the hardware and/or software which converts ready for printer data into raster images. It is also a common term for rasterizing a page image on to the output media.

The print server 120 used in the print production stage 108 is coupled with the job preparation stations 116 and the network server 118 over the network 112. Further, the print server 120 is coupled with the various output devices 122 in the print shop. Note that some output devices 122 may not support electronic transfer of the data to be output and may require a manual step for operation. Such devices may include a special binding machine which requires that the partially finished documents be manually transferred to the binding machine to complete the production. The print server 120 is preferably implemented as a separate computer coupled with the network 112, however, software based print servers running on a network server 118, job preparation station 116 or store front workstation 114 may also be used. In the present embodiment, the print server 120 includes an independent computer workstation, typically running a UNIX or Windows NT operating system, a software print server engine and a software print server application. The print server application offers the user interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary output devices include the Digimaster™ Digital High Volume Printer manufactured by Heidelberg Digital, L.L.C., located in Rochester, N.Y. and the NexPress™ Color printer manufactured by NexPress, Corporation, located in Rochester, N.Y.

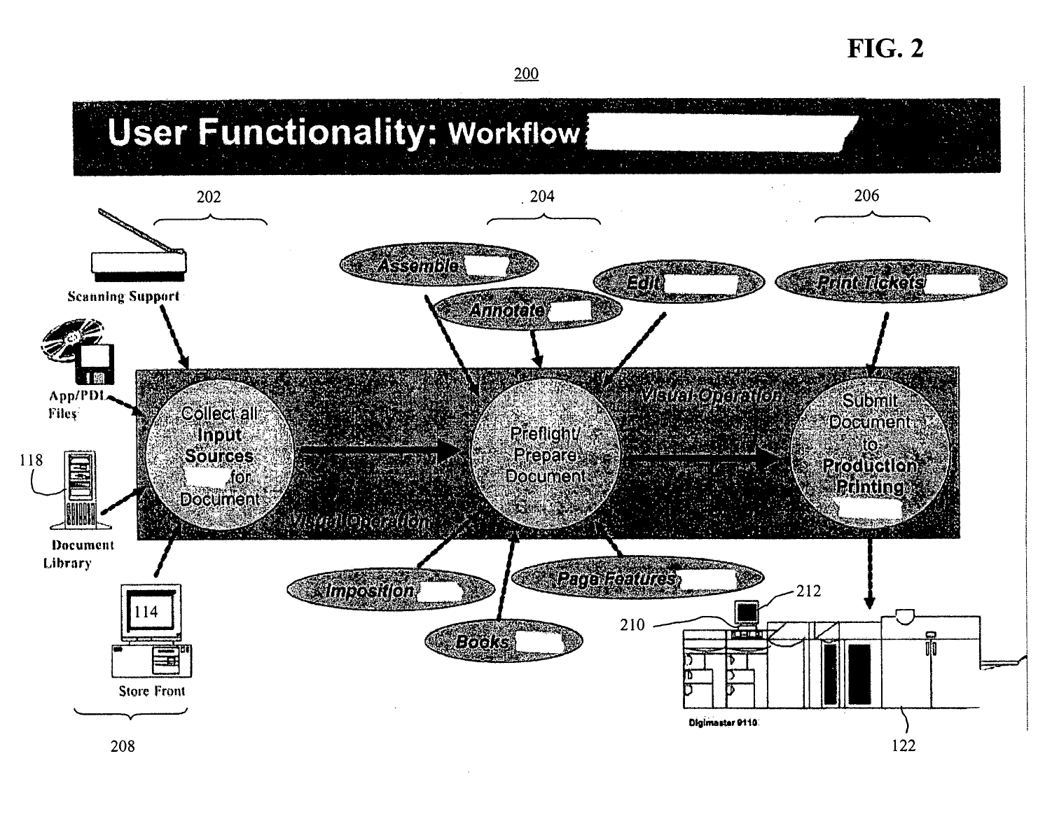

Referring now to FIG. 2, there is shown a flow diagram showing the user functionality workflow 200 of the present embodiment job submission and preparation stages 104, 106. The user workflow includes an input source stage 208, a preflight stage 204 and a production stage 206. In the input source stage 208, all of the documents of the job are collected together from the different input sources 208. As detailed above, all of the collected documents are converted to a ready for printer format, preferably a Portable Document Format™. This conversion can be a manual or automated process or a combination thereof. For example, a special directory can be created on the network server 118 where data files in various file formats can be placed, for example, by the clerk who accepts the documents from the customer and inputs them into the store front workstation 114. Automated logic which watches this directory, will see the placement of files and automatically convert them (or flag them for manual conversion) into a ready for printer format. Any documents which the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process may include a manual or automated determination of the capabilities, skill level or training level of the various operators currently logged into the available job preparation stations 116 as well as the current load/backlog of job in their respective queues. Taking these factors into account, job can be automatically or manually routed to the operator best able to handle the job both technically and in an expedient manner. This functionality can be implemented by creating an operator database which tracks the capabilities, skill level and training level of the various operators who work in the print shop. This database can be coupled with queue management software which balances the loads/backlogs of job at each station 116.

In the preflight stage 204, the documents can be assembled, such as in a book, annotated, edited, and have imposition or other page features applied. Once the documents are prepared for production, they are passed to the production stage 206. In the production stage 206, the prepared documents along with the production instructions (from the tickets) are submitted to the print server or directly to the production output device 122 using a file downloader such as the Print File Downloader™ application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

In the present embodiments, the user functionality workflow is preferably implemented as a workflow management software program and interface executing on the job preparation workstation 116. The present workflow management software is visually oriented using an object oriented graphic user interface (“GUI”) approach which integrates control of the workflow functionality in a single interface. While the visual and operational appearance of the management software is object oriented, the implementation of the software may be by an object oriented programming language or a non-object oriented programming language as are known in the art.

In the GUI interface, documents, tickets and other entities and operations (collectively “objects”) are visually represented on the workstation 116 display, such as with icons, tree structures and pull-down menus, and may be interacted with using known devices and methods such as utilizing a mouse or track ball to control a visually represented pointing device which is then used to click, select, drag and drop the displayed representations. Such manipulation of the visual representations results in manipulation of the underlying objects (documents, tickets, and other entities and operations). Furthermore, the GUI also permits creation and manipulation of relationships and associations among the various objects and visually displays such relationships and associations. Relationships and associations may be displayed, for example, using a hierarchical approach like a tree structure or file folder structure or using some alternate form of visual indication. It will be appreciated that graphic user interfaces are well known in the art and that there are many software development packages available which can be used to develop a GUI. One such package is the Open Software Development Kit available from Microsoft Corporation, located in Redmond, Wash.

Further, the present GUI utilizes a document centric approach providing a centralized viewing window for viewing documents being worked on. In the present embodiment, the document viewing functionality is provided by the Adobe Acrobat software program, manufactured by Adobe Systems, Inc., located in San Jose, Calif.

As was noted above, the workflow management software integrates applications which implement, control or manage the stages of the production printing workflow 100. These applications include inputting documents from various sources, document assembly including the creation and manipulation of books, document editing, document annotation, document library access on the network server 118, setting and manipulation of page features, creation and manipulation of job tickets and printing.

The workflow management software is capable of receiving input from various different sources. Such sources include hard copy originals input via a scanner, native application formats such as the Microsoft Office™ Product suite and desktop publishing applications such as QuarkXpress™, manufactured by Quark. Inc., located in Denver, Colo. and FrameMaker™, manufactured by Adobe Systems, Inc., located in San Jose, Calif. Further the software can accept Tagged Image File Format (“TIFF”) documents as well as documents already in a ready for printer format such as PDF, PS or PCL. For hard copy input via a scanner, the software supports industry standard scanner interfaces, TWAIN, as defined by the TWAIN group located in Boulder Creek, Calif. and the Image and Scanner Interface Specification (“ISIS”) developed by Pixel Translations, Inc., located in San Jose, Calif. and also specified via American National Standards Institute specification ANSI/AIIM MS61-1996. Using these standard interfaces, the workflow management software receives the scanned image data directly in the ready for printer format. An exemplary scanner for use with the present workflow software is the Imagedirect™ Scanner manufactured by Heidelberg Digital, L.L.C., located in Rochester, N.Y.

The present workflow management software also provides ODMA support for interfacing with document libraries. In addition, the provided ODMA support further extends the functionality of the document library to handle management, storage and archiving of compound documents (described below) and tickets. This allows libraries of standardized tickets to be created or facilitates updates and reprints of compound documents such as books.

Once documents are loaded into the workflow management software, tools are provided to perform value added services and prepare the documents for production. Assembly is the process of arranging or rearranging pages or adding or removing pages within a document. Assembly also includes imposition where page positions are forced such as when the first page of a chapter is forced to the front side of the paper. The workflow management software provides cut, copy, paste and move functionality operable on 1 or more pages. This functionality is preferably implemented via pull-down menus, pop up dialog boxes or on screen option palates or buttons as provide by the graphic user interface. In addition, the results of the respective operations are shown in a visual representation of the document in the centralized document viewing window on the job preparation station 116 display.

The workflow management software further provides support for editing and annotating the document. Tools are provided for image object area editing of a scanned page including erase inside and outside an area, cut, move, copy and paste area as well as pencil erase. Page editing tools are also provided for editing on one or more pages including area masking and cropping. Tools are also provided for annotating documents including alpha-numeric and graphic annotations. Exemplary annotations include page numbering and bates stamping. The tools further provide for placing images behind the document content, also known as watermarking. Annotation can be performed on any portion of one or more pages. For alpha-numeric annotations, the font size and style are controllable. In all cases, the results of the respective operations are shown in a visual representation of the document in the centralized document viewing window on the job preparation station 116 display. In the present embodiments, edits or annotations can be created or manipulated by pointing to a visual representation of the document and/or pages within the document and selecting, dragging, dropping or clicking the representation and/or selecting from a menu of options, where the selection of a particular option causes the associated edit or annotation to be applied to the specified portions of the document. Alternatively, a palate of options may be displayed from which the user may choose an option to apply to selected portions of the document. Further, the interface may provide for a dialog box or other visual control for inputting control values for the edit or annotation such as the starting number of a bates range.

The workflow management software preferably provides further support for compound documents which are documents comprised of one or more other documents, such as books comprised of chapters or course packs comprised of one or more excerpted sources. Compound documents take advantage of the object oriented nature of the workflow management software. A compound document (“CD”) is a collection of one or more documents which have a particular ordering to them such as the chapters of a book. The CD further contains an automatically generated assembled document which is a single document containing the whole assembled CD. Tools are provided which allow simple management of the documents of a CD, assembly and updating of the documents into the assembled document and selective document manipulation, such as selective printing, of the documents within the CD. Tools are also provided which can interpret the content of the documents within the CD and automatically generate a table of contents in the assembled document. A compound document otherwise acts just like a document and can be edited, annotated, etc. and have tickets associated with it. Further, a compound document can contain other compound documents such as in the case of a multi-volume book. The individual documents and compound documents within the compound document further retain their independent existence and can be edited or printed independently of the CD and shared with other CD's with those edits being either automatically or manually updated into the assembled document within a particular CD. The workflow management software further displays a visual representation, such as with a hierarchical or tree structure, showing the compound document and any associated documents and tickets. In the present embodiments, compound documents can be created or manipulated by pointing to the visual representations of one or more documents and/or a visual representation of a CD and selecting, dragging, dropping or clicking and/or selecting from a menu of options, where the selection of a particular option causes the associated feature to be applied to the selected documents or compound documents. Alternatively, a palate of options may be displayed from which the user may choose an option to apply to selected compound documents. Further, the interface may provide for a dialog box or other visual control for inputting control values for the compound documents such as margin values. For example, a user may select one or more documents and then choose a create CD option from a pull down menu. The workflow software then creates a visual representation of the CD on the display showing the association of the CD to the selected documents. Alternatively, the user may first create a visual representation of a CD and then drag and drop the visual representations of one or more documents onto the CD visual representation. The workflow software then creates the appropriate logical associations of the data for which the visual representations represent.

The workflow management software is also preferably programmed with data about the different production output devices 122 in the print shop or otherwise available and their capabilities or other equipment, such as finishing equipment, which can be utilized either automatically or manually. The software provides tools which allow the operator to set page features/formatting which are made possible by those specific capabilities. Such page features include the plex of the document such as duplex or simplex (double sided or single sided output), binding options, such as stapling or hole punching and the availability and control settings for handling tab stock or ordered media. The present embodiments preferably support all of the features of the Digimaster™ line of high volume digital printers manufactured by Heidelberg Digital, L.L.C. located in Rochester, N.Y. In the present embodiments, these page features can be set by selecting or pointing to a visual representation of one or more pages and selecting from a menu of options, where the selection of a particular option causes the associated feature to be applied to the selected pages. Alternatively, a palate of options may be displayed from which the user may choose an option to apply to selected pages. Further, the interface may provide for a dialog box or other visual control for inputting control values for the feature such as the type of tab stock. Setting page features for specific pages encodes instructions to the production output device 122 for implementing those features within the ready for printer formatted file. When the production output device 122 receives the file for printing, it will interpret those instructions to implement the desired feature. For page features which the current device 122 cannot handle, the device 122 can signal the operator that manual intervention is required and direct the operator through the appropriate steps to implement the page feature and complete the job. This may include instructing the operator to remove partially finished documents and transfer them to a binding machine for finishing or instructing the operator to load a specific media type or tab stock into the device 122.

Tools are further provided by the workflow management software to support electronic versions of tickets for specifying production output device instructions and parameters, as well as other finishing steps which may or may not be automated, which are global to the document, e.g. job level features or global document attributes. These include such attributes as the general media type or color to use and the method of binding such as stapling. Tickets, also referred to as print tickets or job tickets, can exist independently of documents or compound documents as was mentioned above. They are independently visually represented on the display by the workflow management software. Tools are provided for manipulating tickets, such as saving, storing and associating them with documents or compound documents in addition to editing their options. In the present embodiments, tickets can be manipulated just like documents, using pointing, clicking, selecting, dragging and dropping. For example, a ticket can be associated with a document by selecting the ticket and dragging and dropping it on a particular document. The workflow management software then preferably visually displays the association by showing the ticket under the hierarchy of the document. Once associated, the options set by the ticket will apply to the associated document or compound document. The options represented by the ticket may be set by selecting the ticket to bring up a dialog box or pull down option menu which displays the available options and allows modification of the option values. Tickets associated with documents can be manipulated with the document. For example, saving a document save all of its associated tickets. Furthermore, the workflow management software provides the capabilities to create libraries of standardized tickets which can be used, for example, to standardize procedures across multiple franchised print shops.

Finally, the workflow management software provides tools to send the prepared documents and any associated tickets to the production output device for final production. In the present embodiments, documents or compound documents can be sent to a production output device by selecting, clicking or dragging the visual representation of the document or compound document to a visual representation of the print server or output device. Alternatively, the user may select an appropriate option from a pull-down menu, pop up dialog box or button palate. The workflow management software supports standard interfaces and protocols to production output devices and print servers. Further, tools are provided for managing, selecting and monitoring multiple production output devices. These tools provide visual feed back of each of the devices status to the user such as the current job queues.

As described above, once a document or job is ready to be produced, i.e. has been through job preparation 106 and the pre-flight stage 204 of the workflow, it is transmitted to the production stage 206 of the workflow for final fulfillment 110 and output on the production output device 122. While at this stage, the document/job should be perfect and ready to be printed, errors can and often still occur in the process. Such errors may result from operator error or oversight during job preparation 106 or from data or transmission errors as the job is moved from stage to stage around the print shop's network. Often, these errors comprise either an incorrectly applied page feature (described in more detail below) or a defect in the original document which could have been corrected by the addition or modification of a page feature but either the page feature was never added/modified or somehow got removed or reverted to its original state. These errors represent latent defects which may not be caught until the finished output is proofed. The production stage 206 therefore represents the last opportunity to correct any such latent defects in the job before the actual physical generation of the output, i.e. the last opportunity to “soft-proof” the job. As was noted, an undetected or uncorrected error/defect in a particular job can result in a significant waste of the print shop's resources, including wasted media, wasted machine time and wasted operator time. In addition, these errant jobs incur the cost of sending the job back through job preparation 106 and the pre-flight stage 204 to correct the errors. This cost can be significant depending on the organization of the print shop and the location and work load on the job preparation stations 116 and their operators. Therefore, it is advantageous to provide a system for allowing an operator of a production output device to perform a final review of a job prior to its production and allow for any necessary corrections or adjustments.

Referring back to FIG. 2, the production output device 122, which is preferably a Digimaster™ Digital High Volume Printer manufactured by Heidelberg Digital, L.L.C., located in Rochester, N.Y., further comprises an operator console 210 for controlling the production output device 122. The operator console 210 includes control input devices (not shown) such as a keyboard, mouse, trackball, touch pad, control buttons, knobs or sliders or other input control devices as are known in the art. The operator console 210 further includes a display output device or graphic user interface (GUI) 212 such as a CRT or LCD flat panel display, which may or may not be a touch sensitive input device as well. The display output device 212 displays status and control information about the production output device 122 and accepts input commands from the operator utilizing a graphic user interface coupled with the control input devices.

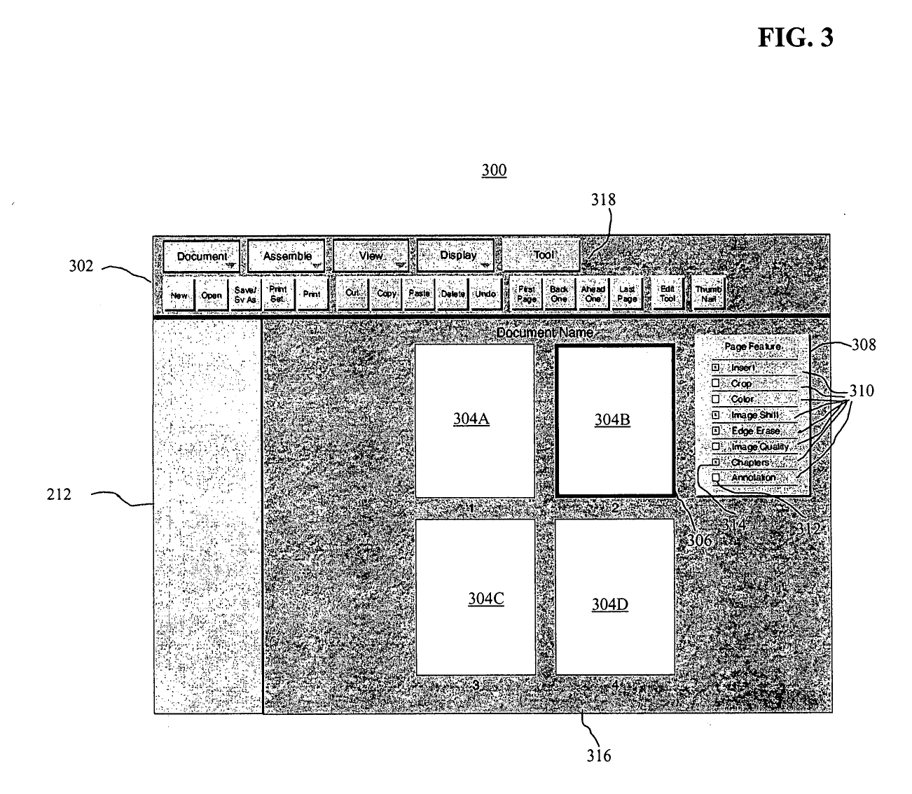

Referring now to FIG. 3, there is shown a first embodiment of a graphic user interface 300 for use on the display output device 212. The interface 300 includes a button palette 302 and a page display window 316. The button palette 300 comprises control buttons 312 which control the various features and options of the interface 300. Exemplary buttons 312 and their functions include a “new” document button, an “open” document button, a “save/save as” document button, “print” document button, “cut”, “copy”, “paste” editing buttons and document and file navigation buttons as are known in the art. These buttons 312 may be interacted with using an input device such as a mouse, keyboard, or touch sensitive display 212. It will be appreciated by one of ordinary skill in the art that such button palettes 302 are well known and may be implemented in many ways and that the functionality of the buttons 312 may be alternatively implemented in other ways including keyboard based key sequences, menus and dialog boxes. The page display window 316 displays the current document which is being worked on. At any given time, a production output device 122 may have multiple jobs stored in an internal print queue/storage queued up for production. The interface 300 allows the operator to choose which job to work on and produce. This current job is displayed in the page display window 316 as described below.

The page display window 316 displays a visual representation of the document which is being produced. As shown in the FIG., one way to display the document is to show four thumbnail images 304A-D of four pages of the document on the screen at a given time. The thumbnail image 304A-D shows a miniature representation of the page as it will look when it is printed, including representations of the content and formatting of the document. The operator can scroll through all of the pages of the document, four at a time, using the control buttons 318 in the button palette 302 (or alternatively, a scroll bar, scroll wheel or other navigation devices which are known in the art) and view all of the pages contained within the document. Alternatively, the page display window 316 can display more or less than four thumbnail images 304A-D, can display larger or smaller thumbnails images 304A-D, can display a single full page at various magnification levels and can be expanded to a full screen mode to utilize the full display area of the display output device 212. In full screen mode, the button palette 302 can be converted to a floating button palette 302 which hovers above the full screen display or can be hidden and triggered to appear when needed by the operator.

The page display window 316 allows the operator to see a quick summary of the page features applied to each of the pages of a particular document. As was discussed above, such page features include formatting attributes such as text margins, type fonts/styles, text alignment, text orientation and line and page breaks. Page features further include media attributes such as whether the paper is pre-hole punched or not, media size (letter, legal, A4, etc.), media color, media finish (glossy, matte, texture, etc.), media thickness and media type such as tab or card stock. Finally, the various page features also include finishing (imaging or printing) attributes such as media source, page image cropping, page image shifting (such as for binder's creep compensation), masking, plex (simplex or duplex), annotation (page numbers, bates numbers, watermarks), insertion (alternate media such as tab stock or colored media), re-ordering, imposition, and binding such as stapling, hole punching or book binding.

As shown in the exemplary embodiment, the page display window shows four page representations 304A-D of four pages of the current document. In the present embodiment, these page representations 304A-D are thumbnail or miniature images 304A-D of the particular pages. When the operator wishes to view the page features which have been applied to a particular page (or group of pages) of the document, he/she selects the desired page (or group of pages) using an input device as described above to select the corresponding thumbnail image 304A-D. It will be appreciated that selection mechanisms in graphic user interfaces are well known. The interface 300 reflects the selection of a page by placing a selection indicator 306 on the selected page such as a darkened border or other visual indicator showing that a particular page (or group of pages) is selected. Once selected, a menu 308 can be viewed which lists descriptors 310 of the various available page features 310 along with an indicator for each feature 310 which indicates whether or not the particular page feature 310 applies to the selected page(s). Preferably, this menu 308 is displayed when an operator clicks a button, such as a right mouse button, located on a mouse type pointing device. In alternative embodiments, the menu 308 can be displayed automatically when a thumbnail image 304A-D is selected or can be displayed when an input key or button is pressed. Further, where the operator console 210 provides a pointing device, the menu 308 can be displayed when the displayed pointer is manipulated over a particular thumbnail image 304A-D (whether or not the thumbnail image 304A-D is selected).

As described above, the menu 308 lists descriptors 310 or descriptive text of the various available page features 310. Associated with each descriptor is an indicator 312 which is binary in operation and indicates whether or not the particular page feature has been set for the selected thumbnail image 304A-D. If the indicator 312 is asserted, this means that the particular page feature has been applied to the page represented by the thumbnail image 304A-D. If the indicator 312 is de-asserted, then the particular page feature has not been applied. In one embodiment, the indicator 312 is a check box which represents assertion of the indicator 312 with a check symbol 314. It will be appreciated that there are many different ways to visually indicate such a binary value. Further, many page features have various optional values associated with them. For example, the plex page feature has the possible values of simplex or duplex. Further, the shifting page feature has a value representing the degree and direction of image shift. In an alternative embodiment, these values can also be displayed in the menu 308 as associated with the page feature descriptor 310 and in place of, or in conjunction with, the indicator 312.

In another alternative embodiment, the operator can use the operator console 210 to select a page feature descriptor 310 from the menu 308. Such a selection can bring up a dialog box (not shown) which allows application or removal of the particular page feature and setting of any optional values. Further, the interface 300 allows formatting and other modifications to the page features of the document to be globally applied to the entire document, such as a shifted margin, or only applied to select pages. Further, in still another alternative embodiment, the interface 300 can also detect conflicts between page features and page features which are improperly set. For example, the interface 300 can determine that an annotation has been placed so as to run off the edge of the media. Further, the interface 300 can detect that both stapling and three hole punching have been selected and that the staples are positioned in the same location as the hole punches. Such errors can be flagged such as through an error indicator, dialog box or other warning which informs the operator of the error and allows him to correct it.

In this way, the operator can preview the pages of a document along with the page features that have been set and determine if everything is correct for final production. If there are errors, the operator can immediately correct the errors without having to return the job to the job preparation stations 116. The corrections can be immediately made and previewed for correctness and then the job can be produced on the production output device 122.

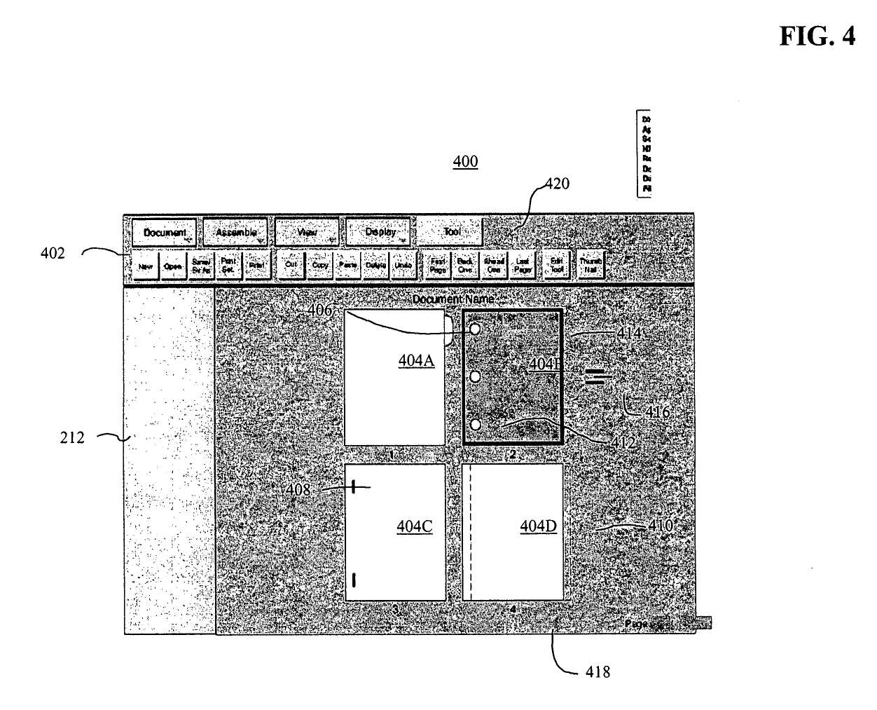

Referring to FIG. 4, there is shown a second embodiment of a graphic user interface 400 for use on the display output device 212. The interface 400 is identical to the interface 300 and includes a button palette 402 with buttons 420 and a page display window 418 which shows thumbnail images 404A-D representing the pages of the document to be produced. Further, interface 400 provides for a symbolic attribute representation or representative icons of the applied page features (media/finishing attributes) to be displayed in conjunction with the thumbnail images 404A-D. The application of particular page features is visually represented in the page display window 418 on the corresponding thumbnail image 404A-D. For example, application of a page feature for three hole punching would cause visual representations of the holes 406 in the pages to appear on the thumbnail image 404B of the selected pages. This would allow the operator to see the results of the page feature and determine, for example, if the body text of the page is too close to the holes.

Each page feature or media/finishing attribute is associated with an icon or symbolic attribute representation which can be overlaid on the thumbnail image 404A-D. Other examples include displaying a tab 406 on the thumbnail image 404A to indicate that the particular page is to be printed on tab stock, displaying the thumbnail image 404B in a particular grayscale, pattern or color 414 to indicate that the page is to be printed on a certain color media, displaying staple symbols 408 on the thumbnail image 404C to indicate the location for stapling and displaying a margin guide 410 on the thumbnail image 404D to indicate image shifting. Where a symbolic attribute representation cannot be easily inserted or intuitively displayed with the thumbnail image 404A-D, an icon 416 can be displayed next to the thumbnail image 404A-D to indicate the presence of the particular page feature. For example, and icon 416 can be displayed next to the thumbnail image 404B to indicate a page insertion. In this particular example, additional information can be displayed next to, or otherwise in conjunction with, the icon 416 indicating, for example, the page number of the inserted page(s) relative to the number of total pages in the document to indicate the to the operator the impact on the page count of the insertion. It will be appreciated that each of the symbolic attribute representations and icons can be displayed alone or in combination with others to reflect the combination of page features applied to the particular page. Further, the symbolic attribute representations/icons, or combinations thereof, can further be displayed in conjunction with status or settings data indicating to the operator information about the applied page features. Note that while the page features are visible in the page display window 418, they are inserted in the ready for printer format code so as not to actually print out when the document is sent to the production output device. The logic which implements the symbolic representations of the page and document features knows of the capabilities and operations of the production output device 122. For example, the logic knows that the automatic stapler in the production output device 122 can only staple along the left edge of the paper. Therefore, if the job calls for stapling along the right edge, an error can be flagged.

Particular page features can be added, deleted or modified by pointing to the symbolic attribute representation or icon with the pointing device and selecting it to bring up a dialog box for controlling the particular feature. Further, menus or buttons can be provided which list the available page features and offer the ability to apply a particular page feature to a selected page representation 404A-D or group of selected page representations 404A-D. Alternatively, the interface 400 can be combined with the interface 300 to offer a pop-up menu 308 for viewing, selecting, adding and modifying page features in conjunction with the symbolic attribute representations displayed in conjunction with the page representations 404A-D. For example, using the input device to select or click on an icon/symbolic attribute representation can display a pop up menu or dialog box allowing the user to configure or modify the represented page feature.

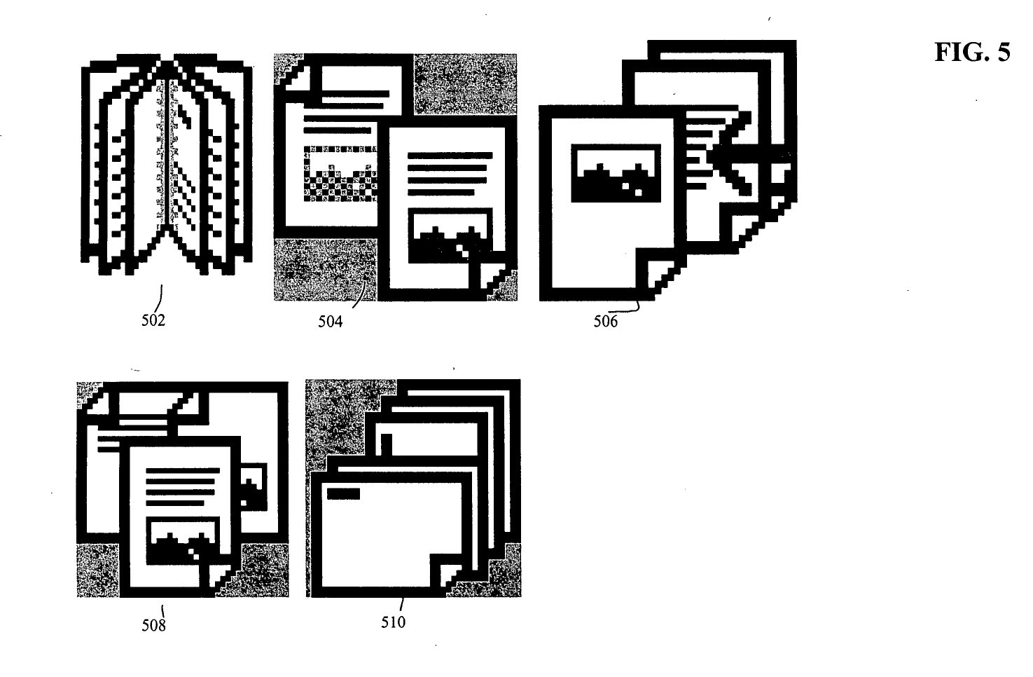

Referring to FIG. 5, there are shown symbolic attribute representations or icons corresponding to various other page features, which include media and finishing attributes, which can be used with the disclosed embodiments. Such icons/features include chapters 502 which indicates the application of a form of imposition where the first page of chapter is forced to be the front page of a double sided page, copy improvement 504 which indicates the application of special filters or image processing algorithms to enhance the reproduction of the particular page (for photographs, etc.), page insertion 506 which shows that a photo, tab or other page is inserted at the indicated point (similar to the icon 416 in FIG. 4), overlay 508 indicating the application of an image or text overlay or watermark and sub-set stapling 510 indicating that a sub-set(s) of the pages within the document are to be stapled or stapled differently than the remaining pages of the document (this is similar and can be combined with icon 408 in FIG. 4 which can be used to show stapling all the way through the entire document. Other page features that can also be represented are edge erase (representative icons not shown in FIG.). It will be appreciated that there are many different ways to visually represent the various page features and that the disclosed embodiments are applicable to page features and icons presently existing and later developed.

It will further be appreciated that the graphic user interface 300/400 may also be implemented as a remote interface to the production output device 122 allowing control of the production output device 122 from a remote location. In one alternative embodiment, the graphic user interface is implemented as a client using Hypertext Markup Language (“HTML”) and Hypertext Transport Protocol (“HTTP”) layered on a Transport Control Protocol/Internet Protocol (“TCP/IP”) based network to communicate with an HTTP server located in the production output device 122. The production output device will have a controller with an operating system. The operating system (OS) can usually support a web hosting service (such as Windows 8000 OS, which includes the Internet Information Services (IIS)), which can be set up to host a web site with a unique IP address or URL. Other OS's have similar capabilities, such as Sun Solaris or Linux operating systems. Based on this capability, a web site is configured within in each printing system. The website can be assigned a default name, which can correspond to a convenient piece of data such as the unit serial number, or the trademark or logo of the printing company. Upon installation of the printing system, usually a static IP address is assigned. This IP address then becomes the identifier for the engine URL inside the customer LAN. The Customer's main IP address is then resolved by the DNS (Domain Name System) as the address for the engine URL and the connection request is forwarded to the print engine's internal IP address to establish http:// based communication.

For example, the Printing System Default URL could be http://Printshop.com. The manufacturer's service representative would input the machine URL into a browser such as Internet Explorer or Netscape. The Internet DNS Server would link the URL (such as http://DHV183456.printshop.abcp.com) with the printshop's IP Address such as 816.831.81.165, which is printshop's external IP address. The URL request comes in on secure port 443 at the customer's firewall and is forwarded to printing system's internal IP address such as 198.168.183.83 on a secure port. Printshop's IT department enters the manufacturer's IP address on the “approved list” and “port forwards” the request to the printing system's internal IP address, such as 198.168.183.83. Printshop's firewall requests a Server Certificate (such the functionality provided as that provided by Microsoft) and establishes highly encrypted communication with the manufacturer's server. The printing system accepts the request also on secure internet http port 443 and establishes a secure connection as described earlier. The printing system web server (such as the Microsoft Internet Information Services or IIS server) requests authentication via User Name and Password. This information is encrypted to assure security. Since this connection is established as an http:// internet connection, the remote user (manufacturer's representative) does not have actual physical access to customer's LAN and has a limited set of permissions only within the web root directory of the printing system controller. This also avoids the need for a user name/password privileges on the customer LAN.

Alternatively, the use of direct internet connection to the printing system avoids the need for port forwarding and access via customer's firewall, thereby completely bypassing the customer's LAN.

Each Print System's web server will be able to serve up information such as (but not limited to): Machine Home Page; Printer Status; Direct Job Submission; Print Queue; Usage Meters; Print Engine Configuration; Update Manager, etc. Both the manufacturer and the customer can access the machine web site and get current up-to-date information in the above areas.

In the case of multiple printing systems, when a print production management server is installed, the web site is installed on the production print server and can provide a combined status of all the attached printing systems. Typical use cases include but are not limited to: Instant view of printer status (up, down, maintenance due, accessory status, error logs, performance logs/uptime data, etc); Upload job-by-job completion data to an upstream application; View printer queue, alter queue, hold/release jobs; upload information to central Production Server; Submit jobs directly to Printer Hot Folder (drag into hot folder window in the web site); View usage meters, upload usage data to upstream management application; View Print Engine Configuration, serial numbers, software versions for all subsystems; Display “Update Available” message when manufacturers servers post software updates; Facilitate the software download and update process.

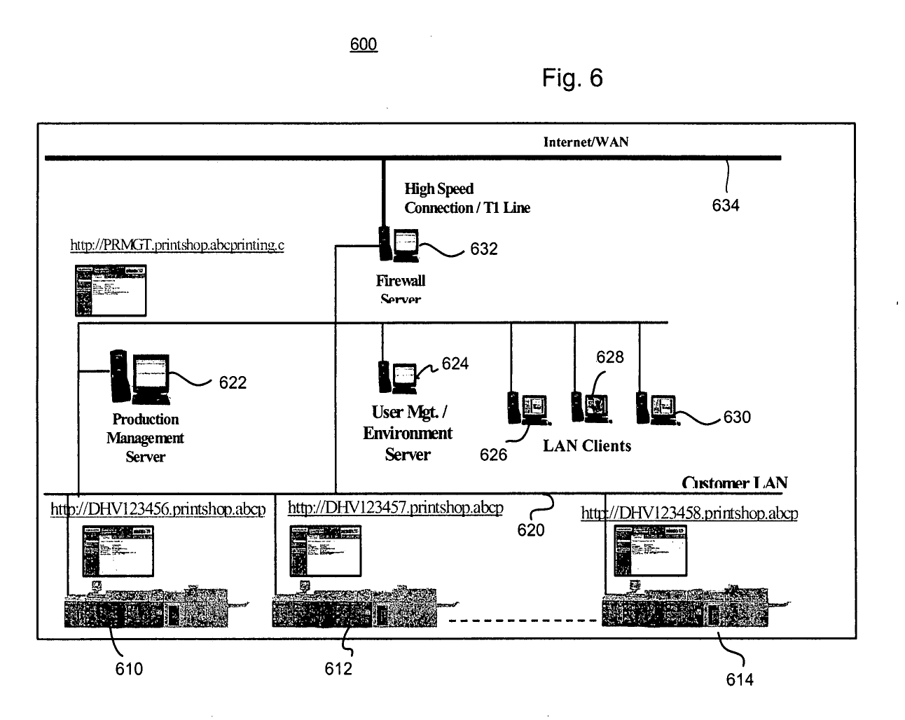

FIG. 6 illustrates a web based printing system 600 connecting series of printers 610, 612, 614 communicating on a Customer LAN 620 to a LAN production management server 622, a user management environment server 624 and a series of LAN client machines 626, 628, 630, through a firewall server 632 to the internet on a Wide Area Network (WAN) 634 for communication with other print management systems (not shown). The LAN and WAN lines facilitate high speed communication over the internet as described herein. The printing system hosts its own web site with its own URL http based address and may enable secure access to Printing System without User Permission Access in customer's LAN and utilize secure internet http port, SSL encryption, Server Certificates, web site user authentication, or any other applicable means of creating secure connection. The Web site may enable either the manufacturer or customer (user) to obtain data from the system in a secure manner without direct access to the OS file system, such data including error codes, usage, performance data, etc. The web site may facilitate remote administration of software/firmware updates and may be scaleable to move upstream to production management server and thereby administer multiple units in similar manner. The web site may mirror itself in on a server in DMZ (Demilitarized Zone), thus avoiding the necessity of direct connection to the system and substituting direct connection with a virtual connection, which may require outbound communication only and invoke inbound communication ONLY with customer (operator) approval. The website may facilitate software and firmware updates in a semi-automatic or fully automatic manner. The website may enables direct job submission to system print queue without accessing the system User Interface, Print Driver or any other means customarily used to submit jobs. Such job submission may be accomplished by dragging and dropping said print job file over the web site browser view on the screen as one example. The website may be hosted on the printing system and may enable remote management of print queues.

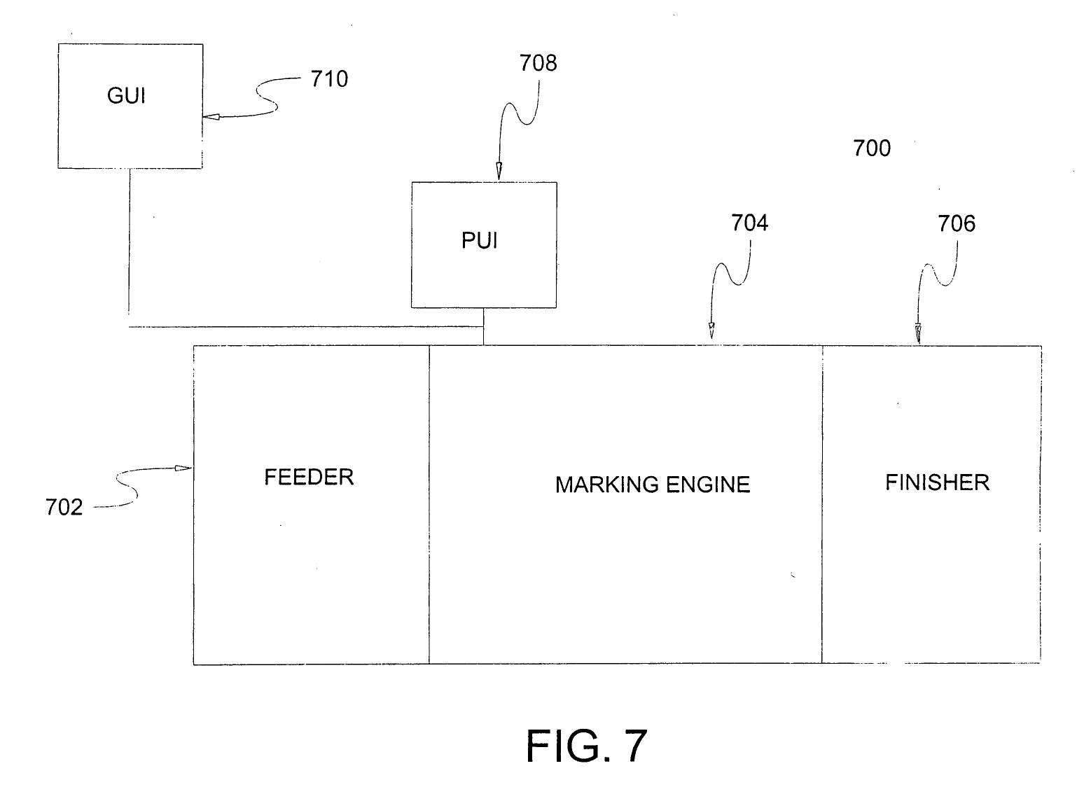

FIG. 7 represents a block diagram of an image-forming machine 700 having a graphic user interface (GUI) 710 with interconnection architecture where a software application implements a functionality and provides a plug-in interface with another software application. As described below, the software application implements a document or image-viewing functionality and also provides the plug-in interface to another software application implementing an image-forming management functionality in the image-forming machine 700. Other or additional software applications may be used to implement a functionality and provide a plug-in interface. While particular configurations and arrangements are shown, other configurations and arrangements may be used including those with other and additional components.

The image-forming machine 700 may be an electrophotographic device such as one of the Digimaster® digital printers manufactured by Heidelberg Digital L.L.C. located in Rochester, N.Y. The image-forming machine 700 also may be another electrophotographic machine, a photocopy machine, a printing device, or the like. In addition to the GUI 710, the image-forming machine 700 has a feeder 702, a marking engine 704, a finisher 706, and a printer use interface (PUI) 708. The image-forming machine 700 may have other equipment. The feeder 702, the marking engine 704, the finisher 706, and the printer user interface 708 may be separate or integrated components. The printer user interface 708 may be a display unit with push buttons (not shown) or other activation means for inputting control parameters to the image-forming machine 700.

The feeder 702 provides the printing or copying sheets to the printing engine 704. The sheets may be one or a combination of paper, transparencies, and other medium. The sheets may be configured with pre-punched holes, tabs, and the like. In one aspect, the marking engine 704 includes a photoconductor (not shown), one or more chargers (not shown), an exposure machine (not shown), a toning station (not shown), and a fuser station (not shown). In operation, the photoconductor is selectively charged and optically exposed to form an electrostatic latent image on the surface. Toner is deposited onto the photoconductor surface. The toner is charged, thus adhering to the photoconductor surface in areas corresponding to the electrostatic latent image. The toner image is transferred onto the sheet. In the fuser station, the sheet is heated causing the toner to fix or adhere to the paper or other medium. The sheet exits the marking engine 704 and enters the finisher 706, which may discharge the sheet as is or may perform one or more finishing operations such as stapling, folding, and inserting an inserted sheet.

In one aspect, the GUI 710 is a separate component such as a dedicated desktop or other personal computer operatively connected to the image-forming machine 700. The GUI 710 also may be integrated with the printer user interface 708 or other components of the image-forming machine 700. The GUI 710 is operatively connected to a logic control unit (not shown) in the image-forming machine 700. Operatively connected includes transmission or communication means such as electrical, radio, network, and the like. The GUI and the logic control unit also may be integrated into the same component. The logic control unit is connected to control the feeder 702, the marking engine 704, the finisher 706, and the printer user interface 708. The GUI 710 comprises a display screen (not shown) and an interfacing means such as a touch screen (not shown), a keyboard (not shown), a mouse (not shown), a track ball (not shown), or a combination thereof. The GUI 710 also may include tear-off menus, floating buttons, dialog boxes, alternate keyboard command and mouse shortcuts, and other alternative user interfaces.

The GUI 710 provides visual interaction with the image-forming machine 700 using one or more applications that implement one or more functionalities such as a document or image viewing functionality and an image-forming management functionality. In one aspect, document and image-forming management functionalities are implemented via a plug-in architecture. A plug-in architecture allows enhancements and updates to be incorporated in a simpler and more efficient manner and without requiring recompilation of all of the program codes that implement the functionalities. Other architectures may be used.

The document or image viewing functionality provides a viewing window for viewing electronic images of the original documents in a print job by providing the ability to view each page. In one aspect, an Adobe Acrobat®, Version 5.0 software application, manufactured by Adobe Systems, Inc. located in San Jose, Calif., implements the document or image viewing functionality on the image-forming machine 700. The documents are formatted in Portable Document Format (PDF) which is a universal electronic document file format that preserves all the fonts, formatting, graphics, and color of any source document, regardless of the application and platform used to create it. PDF files are compact and can be shared, viewed, navigated, and printed exactly as intended. It also has a plug-in interface architecture that lets one incorporate the image-forming management functionality. Other document or image viewing software applications may be used. The image-forming management functionality integrates applications that implement, control, or manage the image-forming machine 700. The image-forming management functionality is a graphical user interface that visually represents objects (documents, tickets, other entities, operations, and the like) with elements such as icons, tree structures, pull-down menus, pop-up menus, tool buttons, slide controls, and the like which are well known in the art. A user may interact with the image-forming management functionality using various interaction means such as the touch screen, the mouse, the track ball, and the keyboard. Such interaction with the visual representations results in manipulation of the underlying objects. While the image-forming management functionality may have an object-oriented appearance, the implementation of the functionality may be by an object oriented programming language or a non-object oriented programming language. In one aspect, the image-forming management functionality is implemented by an ImageSmart® Document Mastering SmartBoard™ software application used with Digimaster® digital printers manufactured by Heidelberg Digital L.L.C. located in Rochester, N.Y. Other image-forming management software applications may be used.

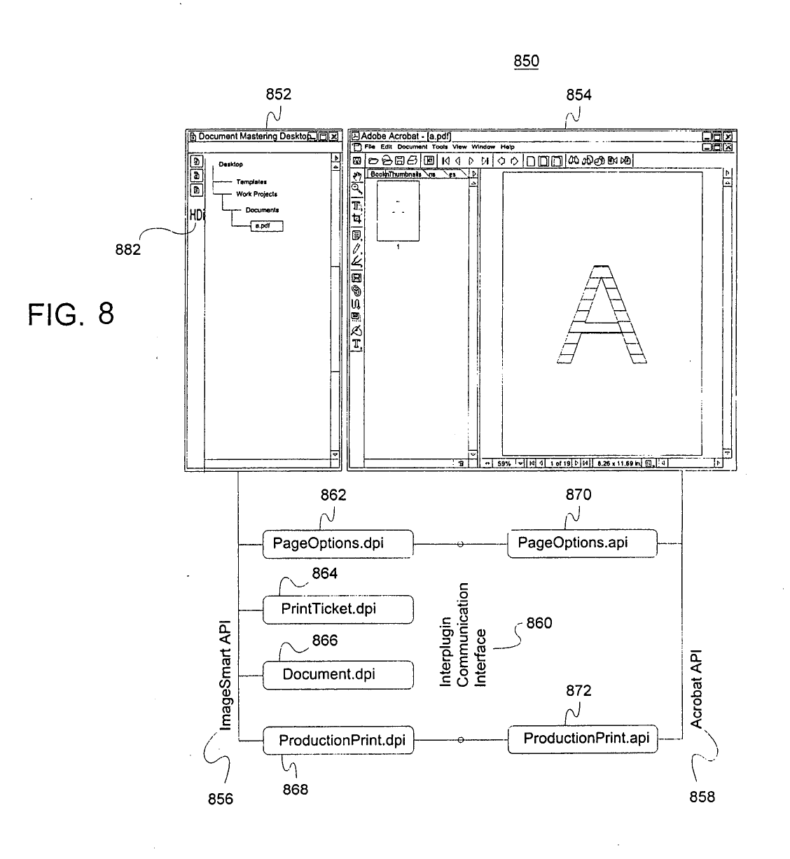

FIG. 8 represents a block diagram showing the interconnection architecture 850 of the ImageSmart® Document Mastering SmartBoard™ software application 852 with Adobe Acrobat® software application 854 according to a first embodiment. The SmartBoard™ 852 has an ImageSmart application-programming interface 856 connected to a page options desktop plug-in 862, a print ticket desktop plug-in 864, a document desktop plug-in 866, and a production print desktop plug-in 868. The desktop plug-in packages 862, 864, 866, and 868 are additional software applications provided with the ImageSmart® Document Mastering SmartBoard™ 852, which serves as a master plug-in to host the aforementioned desktop plug-in packages and additional plug-ins. The desktop plug-in packages 862, 864, 866, and 868 may be provided by one or more other software applications. The page options plug-in enables a user to assign page level print options in a visual manner by creating elements like menu entries and toolbar icons that will either bring up the user interface, or will assign pre-defined sets of page features to the pages that are selected in the document viewing function's thumbnail pane. In addition, it may also create entries in the image-forming management function's window to display available page feature templates and a summary of the page features assigned to a document. The print ticket plug-in displays, manages, stores and retrieves saved job settings for each document on the user interface. It is responsible for retrieving and converting existing job ticket settings generated from other systems and saving the converted settings when the document is saved. The document plug-in maintains the image-forming management function's view of all open documents or files and implements the image-forming management services to open, save, close, and select documents. Additionally, the document plug-in exports a host function table (HFT), which provides an interface between plug-ins for sharing common information about opened documents. The document plug-in provides services (such as open, save, close, select, etc.) for displaying information about and the management of documents. These services are presented to the user through menus, tool buttons, drag and drop, document trees, etc. The document plug-in is also responsible for presenting and maintaining information displayed to the user about opened documents. Typical attributes may include, but are not limited to file name, file location, document title, and author. The production print facilitates the print output from the image-forming management function. It communicates with other plug-ins and the print engine and is responsible for communicating with the print engine and sending the document and associated data to the print engine. The Adobe Acrobat® 854 has an Acrobat application-programming interface 858 connected to a page options Acrobat plug-in 870 and a production print Acrobat plug-in 872. The plug-in packages 870 and 872 are additional software applications which support or are provided with the image-forming management package 852. The plug-in packages supporting the Adobe Acrobat® application-programming interface (Acrobat API) 870 and 872 may be provided by one or more other software applications. The SmartBoard™ plug-ins having interaction with the Adobe Acrobat™ plug-ins have corresponding plug-ins such as page options and production print. The page options desktop plug-in 862 and the production print desktop plug-in 868 are connected respectively to the page options Acrobat plug-in 870 and the production print Acrobat plug-in 872 through an inter-plug-in interface 860. Additional and different plug-ins may be used and may have different configurations.

In addition, the SmartBoard™ has one or more hyperlinks 882 to navigate directly to the customer, printers or other users website. The end customer outside of the print shop could use the SmartBoard™ to prepare a job for the print shop by selecting all the job specifications and embedding them into the PDF file by simply saving the document. Once the end user is ready to submit the job to the printer they will click on the link 882 to the print shop and submit the print job as New Order, Re-order/Re-print or check the status of submitted jobs. The link could also be configurable at the customers site to link directly to a website or FTP site to upload a SmartBoard™ PDF file for production. This gives a printer the benefit of receiving print ready files from the customer and producing the production print job quicker and delivering in much faster timeframe to the end customer. The HTML format provides the ability to link text and/or an image to another document or section of a document. A browser highlights the identified text or image with color and/or underlines to indicate that it is a hypertext link (often shortened to hyperlink or just link). The World Wide Web uses Uniform Resource Locators (URLs) to specify the location of files on other servers so that not only can one point to a file in a directory, but that file and that directory can exist on any machine on the network for linking to the HTML. Although hyperlink 882 is shown within the software application 852 for exemplary purposes, it may reside anywhere within the interconnection architecture 850. The hyperlink 882 may be configured to look like the trademark or logo of the identity to which it is linked.

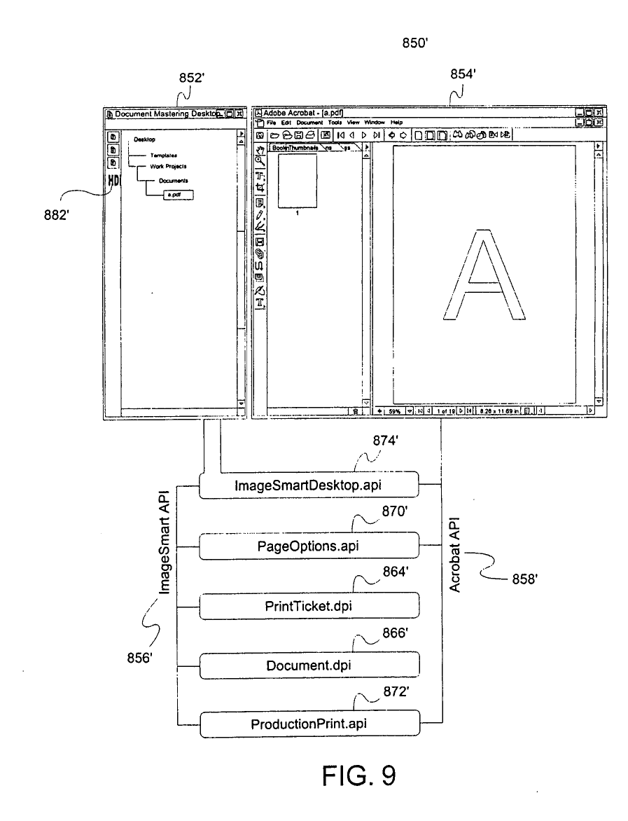

FIG. 9 represents a block diagram showing the interconnection architecture 850′ of the ImageSmart® Document Mastering SmartBoard™ software application 852′ with the Adobe Acrobat® software application 854′ according to a second embodiment. The SmartBoard™ 852′ has an ImageSmart application-programming interface 856′. The Adobe Acrobat® 854′ has an Acrobat application-programming interface 858′. The page options plug-in 870′ and a production print plug-in 872′ that are provided with the ImageSmart® Document Mastering SmartBoard™ 874′ interact with the SmartBoard application-programming interface 856′ and with the Acrobat application-programming interface 858′. A print ticket plug-in 864′ and a document desktop plug-in 866′ also are provided with the ImageSmart® Document Mastering SmartBoard™, but do not interface with the Acrobat application-programming interface 858′. The plug-in packages 864′, 866′ 870′, and 872′ may be provided by one or more other software applications. The ImageSmart® Document Mastering SmartBoard™ software exports a plug-in interface and also is a plug-in to the Adobe Acrobat® application. The SmartBoard™ plug-ins 870′, 872′, and 874′ support both interfaces 856′ and 858′ so that the SmartBoard™ and the Adobe Acrobat® may share the same plug-ins. By having one or more shared plug-ins that support two interfaces, there is less programming overhead. There also are fewer plug-ins to develop and fewer interfaces to support such as an inter-plug-in communication mechanism. One or more hyperlinks 882′ are provided to navigate directly to the customer, printers or other users website.

The Adobe Acrobat® or other software application 854′ provides one functionality and essentially acts as a stand alone application. The ImageSmart® or another software application 852′ provides an additional functionality and essentially becomes a “plug-in” for the Adobe Acrobat®. Accordingly, the document or image viewing functionality, the image-forming management functionality, and subordinate plug-in packages run essentially in the same process space, thus reducing or eliminating the need for complex synchronization schemes. The ImageSmart® or other application also supports its own plug-in interface. Subordinate plug-in packages may be shared between the Acrobat and ImageSmart application using both plug-in interfaces, such as the image-forming management API 956 and the Acrobat application programming interface 854′. Alternatively, some plug-ins may only support the image-forming management API 956.

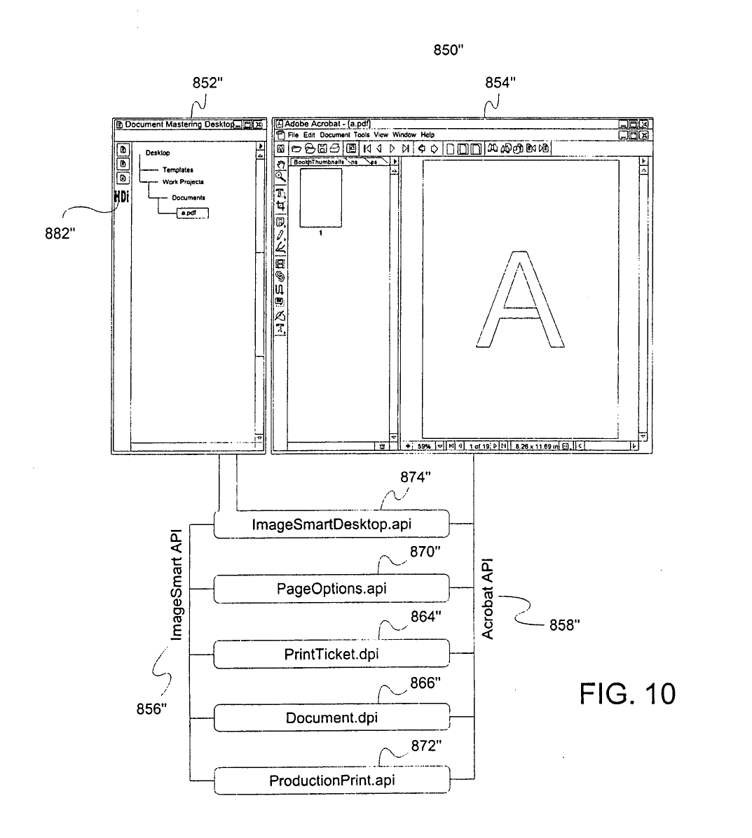

FIG. 10 represents a block diagram showing interconnection architecture 850″ of the ImageSmart® Document Mastering SmartBoard™ software application 852″ with Adobe Acrobat® software application 854″ according to a third embodiment. The SmartBoard™ 852″ has an ImageSmart® application-programming interface 856″. The Adobe Acrobat® 854 has an Acrobat application-programming interface 852″. The ImageSmart® application-programming interface 856″ interfaces or connects with the Acrobat application-programming interface 852″ through a page options plug-in 870″, a production print plug-in 878″, an ImageSmart® Desktop plug-in 874″, a print ticket plug-in 864″, and a document plug-in 866″. The plug-in packages 864″, 866″, 870″, and 872″ are provided with the ImageSmart® Document Mastering SmartBoard™ software application. The plug-in packages 864″, 866″, 870″, and 872″ may be provided by one or more other software applications. As previously discussed, the ImageSmart® or other software application exports a plug-in interface and essentially is a plug-in to the Adobe Acrobat® or another software application. One or more hyperlinks 882″ are provided to navigate directly to the customer, printers or other users website.

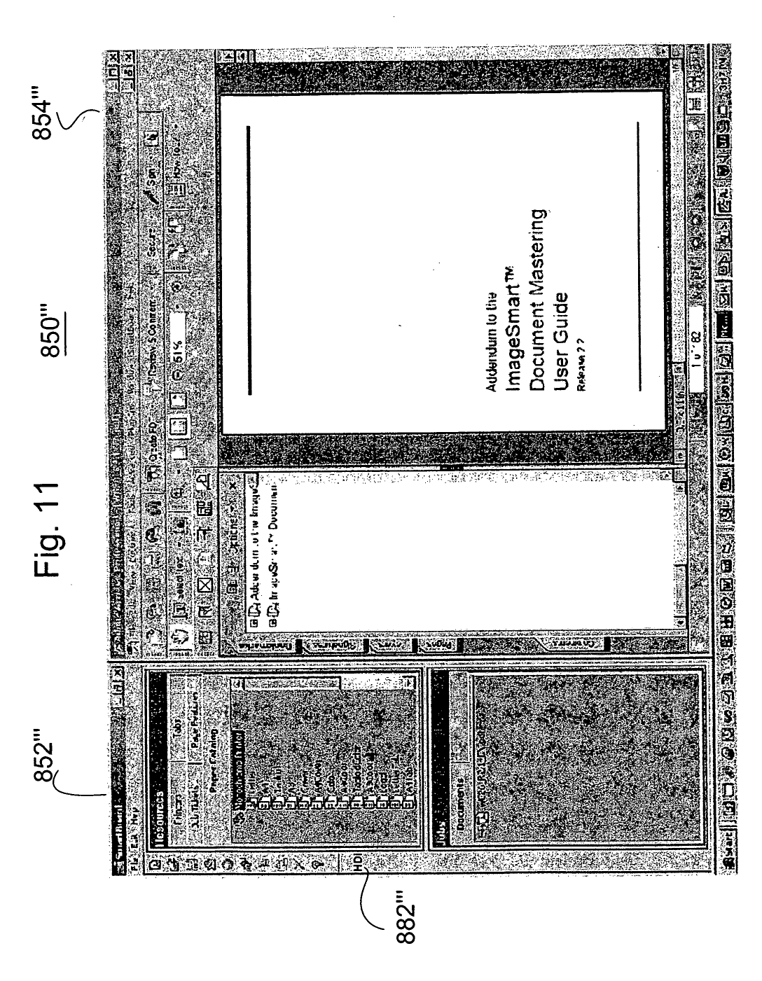

FIG. 11 represents a block diagram showing interconnection architecture 850′″ of the ImageSmart® Document Mastering SmartBoard™ software application 852′″ with Adobe Acrobat® software application 854′″ according to a fourth embodiment. The SmartBoard™ 852′″ has an ImageSmart application-programming interface. The Adobe Acrobat® 854′″ has an Acrobat application-programming interface. One or more hyperlinks 882′″ are provided to navigate directly to the customer, printers or other users website.

It is therefore intended that the foregoing detailed description be regarded as illustrative rather than limiting, and that it be understood that it is the following claims, including all equivalents, that are intended to define the spirit and scope of this invention.

1. A method of controlling a printer, comprising:
providing a printer with software to host its own web site, wherein the printer has its own URL http based address;
providing a user interface to interact with the printer;
interconnecting the user interface to the internet in order to provide access to the printer.

2. A method in accordance with claim 1, wherein access to the printer is secure access.

3. A method in accordance with claim 1, wherein access to the printer is enabled in a secure manner without direct access to the printer OS file system.

4. A method in accordance with claim 1, wherein access to the printer enables remote administration of software/firmware updates.

5. A method in accordance with claim 1, wherein the printer Web site is scaleable to move upstream to a multiple printer management server which thereby controls multiple printers.

6. A method in accordance with claim 1, wherein the printer Web site enables direct job submission to a system print queue without accessing the system User Interface.

7. A method in accordance with claim 1, wherein the printer Web site enables direct job submission to a system print queue without accessing the printer driver.

8. A method in accordance with claim 1, wherein the printer Web site enables remote management of print queues.

9. A printing system comprising:
a printer with software to host its own web site, wherein the printer has its own URL http based address;
a user interface to interact with the printer via the internet in order to provide user access to the printer.

10. A method in accordance with claim 9, wherein access to the printer is secure access.

11. A method in accordance with claim 9, wherein access to the printer is enabled in a secure manner without direct access to the printer OS file system.

12. A method in accordance with claim 9, wherein access to the printer enables remote administration of software/firmware updates.

13. A method in accordance with claim 9, wherein the printer Web site is scaleable to move upstream to a multiple printer management server which thereby controls multiple printers.

14. A method in accordance with claim 9, wherein the printer Web site enables direct job submission to a system print queue without accessing the system User Interface.

15. A method in accordance with claim 9, wherein the printer Web site enables direct job submission to a system print queue without accessing the printer driver.

16. A method in accordance with claim 9, wherein the printer Web site enables remote management of print queues.
